(19) United States
(12) Patent Application Publication
(10) Pub. No.: US 2026/0348530 A1
(43) Pub. Date: Nov. 5, 2026

(54) Method For Checking The Operability Of A Controllable Shut-Off Valve In A Tank Ventilation System

(71) Applicant: Schaeffler Technologies AG & Co. KG, Herzogenaurach (DE)

(72) Inventor: Thomas Pichler, Hohenau (DE)

(73) Assignee: Schaeffler Technologies AG & Co. KG, Herzogenaurach (DE)

(21) Appl. No.: 19/119,676

(22) PCT Filed: Sep. 14, 2023
(86) PCT No.: PCT/EP2023/075212

§ 371 Date: Apr. 9, 2025

(30) Foreign Application Priority Data
Oct. 12, 2022 (DE) 10 2022 210 767.5

(51) Int. Cl. F17C 13/02; F16K 24/04; F16K 37/00; F17C 13/04

(52) U.S. Cl. CPC F17C 13/025; F16K 24/04; F16K 37/005; F17C 13/04; F17C 2205/0326; F17C 2205/0352; F17C 2221/032; F17C 2250/0417; F17C 2250/043

(57) ABSTRACT

An example method for checking a controllable shut-off valve in a tank venting system includes: detecting a closed shut-off valve; activating a meter to measure pressure in a storage region of the tank and a tank pressure; changing the pressure in the storage region; ascertaining a pressure curve in the storage region using output signals from the pressure meter over a first time period and evaluating the ascertained pressure curve to determine whether a first pressure change in the storage space meets a first plausibility criterion; ascertaining pressure curves in the storage region and in the tank using output signals from the storage pressure meter and the tank pressure meter over a second time period if the first plausibility criterion is met; evaluating a correlation between the pressure curves ascertained over the second time period; and identifying a closing fault of the shut-off valve based on the correlation.

### CROSS-REFERENCE TO RELATED APPLICATIONS

This application a U.S. National Stage Application of International Application No. PCT/EP2023/075212 filed Sep. 14, 2023, which designates the United States of America, and claims priority to DE Application No. 10 2022 210 767.5 filed Oct. 12, 2022, the contents of which are hereby incorporated by reference in their entirety.

### TECHNICAL FIELD

The present disclosure relates to tanks. Various embodiments of the teachings herein include systems and/or methods for checking the operability of a controllable shut-off valve in a tank venting system.

### BACKGROUND

Legal regulations require that the fuel vapors arising in a fuel tank do not enter the environment in an uncontrolled manner. Vehicles having an internal combustion engine are therefore usually equipped with a tank venting system. The core element of the tank venting system is a fuel vapor store to which the fuel vapors arising in the fuel tank are fed. The vapors are adsorbed by an adsorbent (usually activated carbon) contained in the fuel vapor store and thus stored. To avoid saturation of the adsorbent, the fuel vapor store must be regenerated from time to time. To do this, the fuel vapor store is flushed with fresh air, whereby the stored fuel vapors are fed to the engine combustion in a controlled

In vehicles driven solely by internal combustion engines, the fuel vapors from the fuel tank are fed to the fuel vapor store continuously. This is possible because the internal combustion engine is the only drive source which is in operation very frequently and the regeneration of the fuel vapor store therefore does not pose a problem. In hybrid drive concepts, that is to say in vehicles having electric motors and internal combustion engines as drive sources, increasingly longer distances are covered without any activation of the internal combustion engine, as a result of which the regeneration possibilities of the fuel vapor store are becoming increasingly rare. For this reason, use is meanwhile being made of pressure tank solutions which are separated from the fuel vapor store by a controllable shut-off valve. In these pressure tanks, the hydrocarbon vapors being emitted therein are retained under pressure until the vapors are allowed to escape toward the fuel vapor store by opening the shut-off valve in a controlled manner.

Legal regulations require the operability of the tank venting system, or the components thereof, to be checked. The operability of the shut-off valve is very relevant in this case since it must be ensured that the fuel tank is depressurized before opening the tank cap in order to prevent uncontrolled escape of hydrocarbons into the environment.

### SUMMARY

The teachings of the present disclosure include methods, computer program products and control apparatus, by means of which the operability of a shut-off valve of a tank venting system can be

checked particularly reliably. For example, some embodiments of the teachings herein include a method for checking the operability of a controllable shut-off valve (1400) in a tank venting system (1000) which has: a tank region (1200) which has a fuel tank (1210), a storage region (1100) which has a fuel vapor store (1110), an exhaust line (1300) which connects the fuel vapor store (1110) and the fuel tank (1210), the controllable shut-off valve (1400) which is arranged in the exhaust line (1300) and which in a closed state prevents pressure equalization between the tank region (1200) and the storage region (1100) and which in an open state allows pressure equalization between the tank region (1200) and the storage region (1100), a pressure changing device (1800) which is connected to the storage region in order to change the pressure in the storage region (1100), a pressure detecting device (1500) which has a storage pressure detecting device (1510) for detecting the pressure in the storage region (1100) and a tank pressure detecting device (1520) for detecting the pressure in the tank region (1200), wherein the method includes: detecting a closed setpoint state of the shut-off valve or controlling the shut-off valve (1400) to occupy the closed setpoint state, activating the pressure detecting device (1500), operating the pressure changing device (1800) to change the pressure in the storage region (1100), ascertaining the pressure curve in the storage region (1100) by detecting output signals from the storage pressure detecting device (1510) over a first time period (TO) and evaluating the ascertained pressure curve to determine whether a first pressure change in the storage space (1100) caused by the operation of the pressure changing device (1800) meets a first plausibility criterion, ascertaining the pressure curves in the storage region (1100) and in the tank region (1200) by detecting output signals from the storage pressure detecting device (1510) and the tank pressure detecting device (1520) over a second time period (T1), in particular if the first plausibility criterion is met, evaluating a correlation between the pressure curves ascertained over the second time period (T1) in the storage region (1100) and in the tank region (1200), and identifying a closing fault of the shut-off valve (1400) on the basis of the correlation between the pressure curves ascertained over the second time period (T1) in the storage region (1100) and in the tank region (1200).

In some embodiments, a closing fault of the shut-off valve (1400) is identified if during the second time period (T1) the gradients of the pressure curves of the pressure in the tank region (1200) and of the pressure in the storage region (1100) have the same mathematical sign and the maximum pressure gradient of the pressure in the tank region (1200) in relation to the maximum pressure gradient of the pressure in the storage region (1100) within the second time period (T1) exceeds a predefined limit value, or the difference between the pressure gradients of the pressure in the tank region (1200) and of the pressure in the storage region (1100) within the second time period (T1) remains within a predefined tolerance range.

In some embodiments, the tank region (1200) has a filling level sensor (1213), the method has an additional step in which a signal from the filling level sensor (1213) is detected and a duration of the second time period (T1) is predefined on the basis of the detected signal from the filling level sensor (1213).

In some embodiments, the method includes ascertaining the pressure curve in the storage region (1100) by detecting output signals from the storage pressure detecting device (1510) over a third time period (T2) and the ascertained pressure curve is evaluated to determine whether a third plausibility criterion is met, wherein the third plausibility criterion is met when the pressure curve ascertained over the third time period (T2) in the storage region is either monotonically increasing or monotonically decreasing, and wherein the relationship between the pressure curves ascertained over the second time period (T1) in the storage region (1100) and in the tank region (1200) is only evaluated if the third plausibility criterion is met.

In some embodiments, the beginning of the second time period (T1) is defined by the start of a time counter or the beginning of the second time period (T1) and of the third time period (T2) is defined by the start of the time counter.

In some embodiments, during the first time period (TO) a fluid mass flow through the storage region (100) caused in particular by the operation of the pressure changing device (1800) is ascertained and in order to meet the first plausibility criterion it is additionally required that a time integral of the fluid mass flow over the first time period (T0) reaches or exceeds a predefined minimum value.

In some embodiments, the method is carried out repeatedly several times.

In some embodiments, in the event that no closing fault of the shut-off valve (1400) is identified, the method includes: controlling the shut-off valve (1400) to occupy the open state, evaluating the detected output signals from the pressure detecting device (1500) to determine whether a second pressure change in the storage space (1100) caused by controlling the shut-off valve (1400) to occupy the open state meets a second plausibility criterion, and identifying an opening fault of the shut-off valve (1400) if the evaluation reveals that the second plausibility criterion is not met.

In some embodiments, the evaluation reveals that the second plausibility criterion is met if after the shut-off valve has been controlled to occupy the open state, a pressure gradient change in the storage region (1100) and/or in the tank region (1200) at least reaches a predefined minimum value or a second pressure gradient in the storage region (1100) and/or in the tank region (1200) is within a predefined second pressure gradient value range, after the shut-off valve has been controlled to occupy the open state, the pressure in the storage region (1100) and/or in the tank region (1200) changes at least by a predefined second pressure amount or the pressure in the storage region (1100) and/or in the tank region (1200) is within a predefined second pressure value range, or after the shut-off valve has been controlled to occupy the open state, a second pressure curve in the storage region (1100) and/or in the tank region (1200) follows a predefined second reference curve or the second pressure curve remains within a predefined second tolerance range around the second reference curve.

In some embodiments, the pressure changing device (1800) has: a ventilation line (1600) via which the fuel vapor store (1110) is connected to the atmosphere, a controllable ventilation valve (1610) which is arranged in the ventilation line (1600) to control the gas flow through the ventilation line (1600), a venting line (1700) via which the fuel vapor store (1110) is connected to a negative-pressure source (2100), and a controllable venting valve (1710) which is arranged in the venting line (1700) to control the gas flow through the venting line (1700), wherein in order to change the pressure in the storage region (1100) the ventilation valve (1610) is closed and the venting valve (1710) is opened in order to produce a negative pressure in the storage region (1100).

In some embodiments, the pressure changing device (1800) has: a ventilation line (1600) via which the fuel vapor store (1110) is connected to the atmosphere, a controllable ventilation valve (1610) which is arranged in the ventilation line (1600) to control the gas flow through the ventilation line (1600), a venting line (1700) via which the fuel vapor store (1110) is connected to a negative-pressure source (2100), and a controllable venting valve (1710) which is arranged in the venting line (1700) to control the gas flow through the venting line (1700), wherein in order to change the pressure in the storage region (1100) the ventilation valve (1610) and the venting valve (1710) are opened in order to produce a negative pressure in the storage region (1100).

In some embodiments, the pressure changing device (1800) has: a ventilation line (1600) via which the fuel vapor store (1110) is connected to the atmosphere, a controllable ventilation valve (1610) which is arranged in the ventilation line (1600) to control the gas flow through the ventilation line (1600), a controllable pump (1620) which is arranged downstream of the ventilation valve (1610) in the ventilation line (1600) to pump ambient air from the atmosphere into the fuel vapor store (1110) in order to produce a positive pressure in the storage region (1100), a venting line (1700) via which the fuel vapor store (1110) is connected to a negative-pressure source (2100), and a controllable venting valve (1710) which is arranged in the venting line (1700) to control the gas flow through the venting line (1700), wherein in order to change the pressure in the storage region (1100) the ventilation valve (1610) is opened, the venting valve (1710) is closed and the pump (1620) is operated in order to produce a positive pressure in the storage region (1100).

In some embodiments, the storage pressure detecting device (1510) constitutes a virtual sensor and the output signals from the storage pressure detecting device (1510) are modeled based on a pressure calculated or measured downstream of the venting valve (1710).

As another example, some embodiments include a computer program product which can be loaded into the storage medium of a computer and which has software code sections according to which one or more of the methods described herein is executed when the computer program product runs on the computer.

As another example, some embodiments include control apparatus (3000) for controlling a tank venting system (1000), having a computer and a storage medium storing a computer program product as described herein.

### BRIEF DESCRIPTION OF THE DRAWINGS

The teachings of the present disclosure are explained in more detail below on the basis of an exemplary embodiment with reference to the appended figures. In the figures:

FIG. 1 shows a schematic illustration of a tank venting system for a motor vehicle incorporating teachings of the present disclosure; and

FIG. 2 shows a flowchart of an exemplary embodiment of a method for checking the tank venting system incorporating teachings of the present disclosure.

### DETAILED DESCRIPTION

Some embodiments of the teachings herein include a method for checking the operability of a controllable shut-off valve in a tank venting system. The tank venting system includes a tank region which has a fuel tank, a storage region which has a fuel vapor store, an exhaust line which connects the fuel vapor store and the fuel tank, the controllable shut-off valve which is arranged in the exhaust line and which in a closed state prevents pressure equalization between the tank region and the storage region and which in an open state allows pressure equalization between the tank region and the storage region. The tank venting system further includes a pressure changing device for changing the pressure in the storage region and a pressure detecting device for detecting the pressure in the storage region and for outputting output values which represent the detected pressure.

The pressure detecting device has a storage pressure detecting device for detecting the pressure in the storage region and a tank pressure detecting device for detecting the pressure in the tank region. In other words, the pressure detecting device has a first pressure detecting device which is designed to detect a pressure in the storage region (also called “storage pressure” in the present disclosure) and it has a second pressure detecting device which is designed to detect a pressure in the tank region (also called “tank pressure” in the present disclosure). The pressure in the tank region is in particular the pressure in the fuel tank; in the case of liquid fuels, it may expediently be the pressure of the gas volume above the liquid level in the fuel tank. The pressure detecting device is activated.

In some embodiments, the shut-off valve is controlled to occupy the closed state. Controlling the shut-off valve to occupy the closed state is understood to mean in particular that a control signal is sent to the shut-off valve, by means of which control signal a closing operation of the shut-off valve is initiated. “Controlling to occupy the closed state” is also understood in the present disclosure to mean when—for example after the vehicle has been started—a closed setpoint state of the shut-off valve is maintained and the shut-off valve is not controlled to occupy an open state.

In some embodiments, alternatively or subsequently to controlling the shut-off valve to occupy the closed state, it is detected whether a closed setpoint state of the shut-off valve is present. The method may be terminated or restarted if no closed setpoint state is present. A closed setpoint state of the shut-off valve is understood to mean in particular a state in which the shut-off valve is not actuated to occupy an open state. For example, in the case of a de-energized closed valve, the closed setpoint state is the de-energized state. Controlling the shut-off valve to occupy the closed setpoint state and/or detecting whether a closed setpoint state of the shut-off valve is present is carried out in particular before or after the pressure detecting device is activated.

In some embodiments, subsequently to controlling the shut-off valve to occupy the closed state or detecting a closed setpoint state, the pressure changing device is operated to change the pressure in the storage region.

In some embodiments, subsequently to operating the pressure changing device, the pressure curve in the storage region is ascertained by detecting output signals from the storage pressure detecting device over a first time period and the ascertained pressure curve is evaluated to determine whether a first pressure change in the storage space caused by the operation of the pressure changing device meets a first plausibility criterion.

In some embodiments, the first plausibility criterion is met if within the first time period the value of the gradient of the pressure curve in the storage region during the first time period remains above a predefined threshold value. In some embodiments, in order to meet the first plausibility criterion, it is, in particular additionally, required that the pressure curve is monotonically increasing during the first time period, i.e. in other words, the pressure gradient has a positive mathematical sign. In some embodiments, the method is terminated or restarted if the first plausibility criterion is not met. In this way, a high reliability of the method can be ensured.

In some embodiments, the pressure curves in the storage region and in the tank region are ascertained by detecting output signals from the storage pressure detecting device or the tank pressure detecting device over a second time period. The second time period can begin at the same time as the first time period, within the first time period, or subsequently to the first time period. In one embodiment of the method, the beginning of the second time period is defined by the start of a time counter.

In some embodiments, in particular at the same time as or subsequently to ascertaining the pressure curves over the second time period, a correlation between the pressure curves ascertained over the second time period in the storage region and in the tank region is evaluated.

In some embodiments, the pressure curves are ascertained over the second time period and/or the correlation is only evaluated if the first plausibility criterion is met. In this embodiment, the second time period expediently begins subsequently to, e.g. directly after, the first time period.

In some embodiments, a closing fault of the shut-off valve is identified on the basis of the correlation between the pressure curves ascertained over the second time period in the storage region and in the tank region. A closing fault of the shut-off valve is understood in the present context to mean in particular a fault of the shut-off valve, in which the sending of the control signal, by means of which the closing operation of the shut-off valve is initiated, does not cause the shut-off valve to close completely—i.e. in particular does not result in the pressure equalization between the tank region and the storage region being completely prevented.

It is checked whether the shut-off valve can be properly closed. In the best case, that is to say if the shut-off valve can be properly closed, the storage region and the tank region are pneumatically separated. As a result, the effective pneumatic volume on which the pressure changing device acts is reduced to the volume of the storage region. In the worst case, that is to say if the shut-off valve is stuck in the open state and the tank region and storage region are pneumatically connected, the effective pneumatic volume is composed of the volume of the tank region and the volume of the storage region and is therefore considerably larger than the pneumatically effective volume in the best case. In addition, in the best case, pressure fluctuations are not transferred between the tank region and the storage region owing to the storage region being pneumatically separated from the tank region. Such pressure fluctuations in the tank region may be caused, for example, by the liquid fuel sloshing around in the fuel tank—e.g. due to movements of the vehicle—or by hydrocarbons which are emitted from the liquid fuel. In the worst case, pressure fluctuations in the tank region may be influenced by the storage region and/or vice versa; pressure fluctuations in the tank region may be attenuated by the pneumatic connection to the fuel vapor store, for example.

In the best case, it is therefore to be expected that the pressure curve in the storage region is less strongly correlated with the pressure curve in the tank region than in the worst case. These different characteristics of the correlation in the best and worst cases allow a particularly reliable diagnosis of closing faults of the shut-off valve. In particular, the risk of misdiagnoses owing to pressure changes in the tank region is particularly low. In particular, when carrying out the method according to the present disclosure, there is advantageously only a very low risk that a closing fault owing to high pressure dynamics in the tank region is not identified.

In some embodiments, a closing fault of the shut-off valve is identified if during the second time period the gradients of the pressure curves of the pressure in the tank region and of the pressure in the storage region have the same mathematical sign and the maximum pressure gradient of the pressure in the tank region within the second time period exceeds a limit value predefined on the basis of the maximum pressure gradient of the pressure in the storage region, or the difference between the pressure gradients of the pressure in the tank region and of the pressure in the storage region within the second time period—i.e. in particular at each point in time within the second time period-remains within a predefined tolerance range. Otherwise—i.e., for example, if the maximum pressure gradient of the pressure in the tank region does not exceed the limit value predefined on the basis of the maximum pressure gradient of the pressure in the storage region within the second time period—in particular no closing fault is identified and a properly closed shut-off valve is assumed.

In some embodiments, the tank region has a filling level sensor. In this case, the method may have an additional step in which a signal from the filling level sensor is detected and a duration of the second time period and/or the threshold value for the first plausibility criterion is predefined on the basis of the detected signal from the filling level sensor. In this way, the measuring time for the pressure curves and a minimum pressure gradient expedient for the reliability of the method can be advantageously adapted in line with the dynamics of the pressure fluctuations in the fuel tank which are dependent on the filling level of the fuel tank. For example, the inertia of the system and the phase delay in the system may depend on the tank filling level.

In some embodiments, the method has an additional method step in which the pressure curve in the storage region is ascertained by detecting output signals from the storage pressure detecting device over a third time period and the ascertained pressure curve is evaluated to determine whether a third plausibility criterion is met. In this case, the third plausibility criterion is in particular assessed to be met when the pressure curve ascertained over the third time period in the storage region is either monotonically increasing or monotonically decreasing. A change in the mathematical sign of the gradient can be caused, for example, by changing the operating parameters of the pressure changing apparatus. If the pressure curve is not monotonically increasing or decreasing, there may be the risk of distortion of the correlation evaluation, for example owing to changes in the phase shifts of the pressure curves or due to the inertia of the system.

In some embodiments, the third time period overlaps with the first and the second time period. For example, the third time period is equal to the second time period, or the third time period is a subsection of the second time period. For example, the beginning of the third time period may likewise be defined by the start of the time counter. In a further variant of this configuration, the relationship between the pressure curves ascertained over the second time period in the storage region and in the tank region is only evaluated if the third plausibility criterion is met. In this configuration of the method, the risk of misdiagnoses owing to switching operations of valves in the tank venting system is advantageously particularly low.

In some embodiments, a fluid mass flow through the storage region is ascertained during the first time period. The fluid mass flow through the storage region is caused in particular by the operation of the pressure changing device. For example, it can be used to flush the fuel vapor store. Expediently, in this configuration, in order to meet the first plausibility criterion it may be additionally required that the fluid mass flow or a time integral of the fluid mass flow over the first time period-i.e. in particular the mass of the fluid which flows out of the storage region or into the storage region during the first time period reaches or exceeds a predefined minimum value. With this configuration, increased reliability of the method can be achieved.

In some embodiments, one or more elements of the method is carried out repeatedly several times, in particular the entirety of the method is carried out repeatedly several times. In this way, particularly reliable diagnosis of closing faults of the shut-off valve can be achieved.

In some embodiments, in the event that no closing fault of the shut-off valve is identified, the following is carried out:
controlling the shut-off valve to occupy the open state,
evaluating the detected output signals from the pressure detecting device to determine whether a second pressure change in the storage space caused by controlling the shut-off valve to occupy the open state meets a second plausibility criterion,
identifying a fault of the shut-off valve if the evaluation reveals that the second plausibility criterion is not met.

By controlling the shut-off valve to occupy the open state, the storage region and the tank region should be pneumatically connected. In the best case, that is to say when the controllable shut-off valve can be properly opened, pressure equalization between the tank region and the storage region takes place. The pneumatic volume suddenly expands by the volume of the tank region. In the worst case, that is to say when the controllable shut-off valve cannot be opened and remains (is stuck) in the closed state, pressure equalization between the tank region and the storage region is still not possible. The pneumatic volume is then still limited to the volume of the storage region. Controlling the shut-off valve to occupy the open state would therefore, in the best case, result in a significant change in the pressure in the storage region. This effect allows a plausibility check to be performed on the pressure curve and therefore a conclusion to be drawn on the operability of the shut-off valve. If it is identified that the second pressure change does not meet the second plausibility criterion, a fault of the shut-off valve is identified. In this worst case, it would be determined that the shut-off valve can no longer be opened or that it is stuck in the closed state.

In some embodiments, the evaluation reveals that the second plausibility criterion is met if
after the shut-off valve has been controlled to occupy the open state, a pressure gradient change in the storage region and/or in the tank region at least reaches a predefined minimum value or a second pressure gradient in the storage region and/or in the tank region is within a predefined second pressure gradient value range, or
after the shut-off valve has been controlled to occupy the open state, the pressure in the storage region and/or in the tank region changes at least by a predefined second minimum amount or the pressure in the storage region and/or in the tank region is within a predefined second pressure value range, or
after the shut-off valve has been controlled to occupy the open state, a second pressure curve in the storage region and/or in the tank region follows a predefined second reference curve or the second pressure curve remains within a predefined second tolerance range around the second reference curve.

In some embodiments, the pressure changing device further has:
a ventilation line via which the fuel vapor store is connected to the atmosphere,
a controllable ventilation valve which is arranged in the ventilation line to control the gas flow through the ventilation line,
a venting line via which the fuel vapor store is connected to a negative-pressure source,
a controllable venting valve which is arranged in the venting line to control the gas flow through the venting line,
   wherein in order to change the pressure in the storage region the ventilation valve is closed and the venting valve is opened in order to produce a negative pressure in the storage region.

Opening the venting valve pneumatically connects the storage region to the negative-pressure source. The negative-pressure source is, for example, an air intake pipe of an internal combustion engine, a Venturi nozzle, a suction jet nozzle, or a negative-pressure pump. In many operating states of the internal combustion engine, a negative pressure prevails in the air intake pipe of the internal combustion engine downstream of a throttling device arranged therein. Connecting the storage space to the air intake pipe at this position results in a gas flow toward the internal combustion engine and in an evacuation of the storage region. According to this exemplary embodiment, activating the pressure changing device leads to a negative pressure in the storage region.

In some embodiments, the pressure changing device has:
a ventilation line via which the fuel vapor store is connected to the atmosphere,
a controllable ventilation valve which is arranged in the ventilation line to control the gas flow through the ventilation line,
a venting line via which the fuel vapor store is connected to a negative-pressure source,
a controllable venting valve which is arranged in the venting line to control the gas flow through the venting line,
   wherein in order to change the pressure in the storage region the ventilation valve and the venting valve are opened in order to produce a negative pressure in the storage region.

This configuration is an alternative to the configuration described above, wherein the ventilation valve is not closed but is opened. This results in a flushing effect in the fuel vapor store, as a result of which the latter is regenerated. Although only a lower negative pressure can be produced in this case, the function check of the shut-off valve can be carried out simultaneously during a flushing operation of the fuel vapor store, this being required from time to time anyway. In order to produce the strongest possible negative pressure, the venting valve can be opened to the maximum and the operation can preferably be carried out when the negative pressure produced by the negative-pressure source is particularly high.

In some embodiments, the pressure changing device has:
a ventilation line via which the fuel vapor store is connected to the atmosphere,
a controllable ventilation valve which is arranged in the ventilation line to control the gas flow through the ventilation line,
a controllable pump which is arranged downstream of the ventilation valve in the ventilation line to pump ambient air from the atmosphere into the fuel vapor store in order to produce a positive pressure in the storage region,
a venting line via which the fuel vapor store is connected to a negative-pressure source,
a controllable venting valve which is arranged in the venting line to control the gas flow through the venting line,
   wherein in order to change the pressure in the storage region the ventilation valve is opened, the venting valve is closed and the pump is operated in order to produce a positive pressure in the storage region.

This configuration constitutes a further alternative to the configuration according to the two configurations described above. Pumping ambient air into the storage region leads to a positive pressure therein.

In some embodiments, the storage pressure detecting device constitutes a virtual sensor. In this case, no physical sensor for detecting the storage pressure needs to be present in the storage region, as may be the case in other configurations of the method. In this way, the method can be carried out at a particularly low cost. In the present configuration, the output signals from the storage pressure detecting device, which represent the pressure in the storage region, are modeled, for example, based on the pressure which is measured downstream of the venting valve or is calculated from one or more other parameters for a location downstream of the venting valve, for example by using a trained neural network.

Some embodiments include a computer program product which can be loaded into the storage medium of a computer. It has software code sections which, when executed on a computer, cause one or more of the methods described herein to be carried out. Furthermore, a data carrier on which the computer program product is stored is disclosed. In one configuration, the computer program product contains characteristic fields, in particular calibrated characteristic fields, for the limit values of the maximum pressure gradient of the pressure in the tank region predefined on the basis of the maximum pressure gradient of the pressure in the storage region, and for the threshold values for the amount of the gradient of the pressure curve in the storage region. Some embodiments include a control apparatus for controlling a tank venting system, which has a computer and a storage medium on which the computer program product is loaded.

Such a control apparatus is further configured with all the necessary interfaces in order to be connected to a tank venting system. When the control apparatus is operated, the computer program product loaded thereon will run and the method will be carried out. With regard to advantages of the computer program product and the control apparatus, reference is made to the embodiments of the method which apply in an analogous manner.

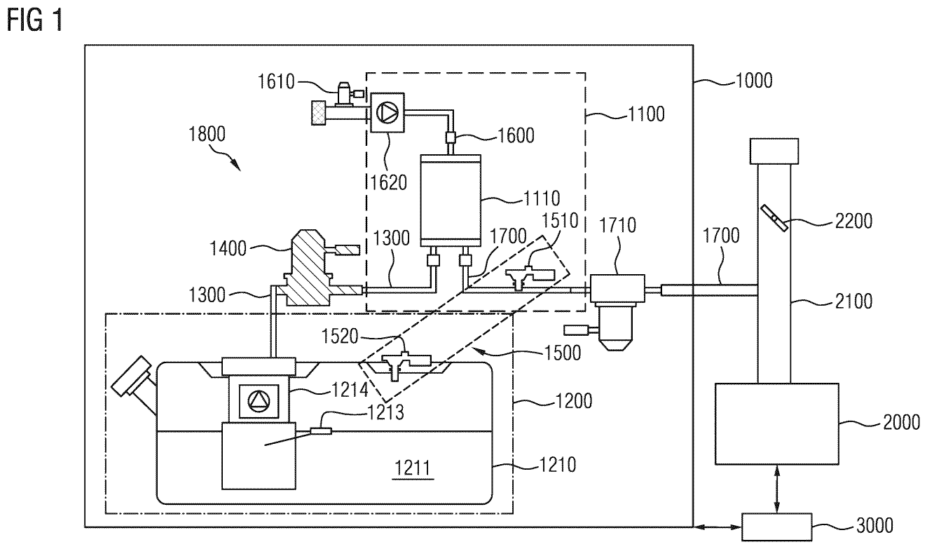

FIG. 1 schematically illustrates a tank venting system 1000 incorporating teachings of the present disclosure for a motor vehicle (not illustrated) having an internal combustion engine 2000. The tank venting system 1000 has a storage region 1100 and a tank region 1200.

The tank region 1200 has a fuel tank 1210 for storing fuel 1211, a filling level sensor 1213 and a conveyor pump 1214 for conveying fuel toward the internal combustion engine 2000.

The storage region 1100 has a fuel vapor store 1110. The fuel vapor store 1110 is in the form of an activated carbon tank and is used to temporarily store hydrocarbons which are emitted from the fuel tank 1210.

The storage region 1100 and tank region 1200 are coupled to each other via an exhaust line 1300. Arranged in the exhaust line 1300 is a controllable shut-off valve 1400 which in a closed state prevents pressure equalization between the tank region 1200 and the storage region 1100 and which in an open state allows pressure equalization between the tank region 1200 and the storage region 1100. The shut-off valve 1400 may be in the form of a pulse-width-modulated, electrical valve.

The tank venting system 1000 further includes a ventilation line 1600 via which the fuel vapor store 1110 is connected to the atmosphere or the environment, and a controllable ventilation valve 1610 which is arranged in the ventilation line 1600 to control the gas flow through the ventilation line 1600. A controllable pump 1620 is further arranged downstream of the ventilation valve 1610 in the ventilation line 1600 and pumps ambient air from the atmosphere into the fuel vapor store 1110 in order to produce a positive pressure in the storage region 1100 when the ventilation valve 1610 is open.

The fuel vapor store 1110 is further connected to a negative-pressure source 2100 via a venting line 1700. In the exemplary embodiment, an air intake pipe 2100 of the internal combustion engine 2000 is used as the negative-pressure source. The venting line opens at a position of the air intake pipe 2100 downstream of a throttling device 2200 (throttle valve) arranged in the air intake pipe 2100. When the internal combustion engine 2000 is operated, a negative pressure prevails at this position. Alternatively, a Venturi nozzle or suction jet nozzle can also be used as the negative-pressure source. A controllable venting valve 1710 is arranged in the venting line 1700 and can be used to control the gas flow through the venting line 1700.

The tank region is delimited by the fuel tank 1210, the shut-off valve 1400 and the intermediate section of the exhaust line 1300. The storage region is delimited by the fuel vapor store 1110, the shut-off valve 1400, that section of the exhaust line 1300 located between the fuel vapor store 1110 and the shut-off valve 1400, the ventilation valve 1610, that section of the ventilation line 1600 located between the fuel vapor store 1110 and the ventilation valve 1610, the venting valve 1710, and that section of the venting line 1700 located between the fuel vapor store 1110 and the venting valve 1710.

The ventilation line 1600, the controllable ventilation valve 1610, the pump 1620, the venting line 1700 and the controllable venting valve 1710 together form a pressure changing device 1800 by means of which the pressure in the storage region 1100 can be changed. In order to produce a positive pressure in the storage region 1100 (relative to the pressure in the tank region 1200), the shut-off valve 1400 is closed, the venting valve 1710 is closed, the ventilation valve 1610 is opened and the pump 1620 is operated. In some embodiments, in order to produce a negative pressure in the storage region 1100 (relative to the pressure in the tank region 1200), the shut-off valve 1400 is closed, the ventilation valve 1610 is closed and the venting valve 1710 is opened, as a result of which the storage region 1100 is connected to the air intake pipe.

The tank venting system further includes a pressure ascertaining device 1500 which has a storage pressure sensor 1510 for detecting the gas pressure in the storage region 1100. The pressure ascertaining device 1500 additionally has a tank pressure sensor 1520 for detecting the gas pressure in the tank region 1200. In the exemplary embodiment of FIG. 1, the storage pressure sensor 1510 is arranged upstream of the venting valve 1710 in the venting line and the tank pressure sensor 1520 is arranged in the fuel tank 1200.

Provision is made for a control apparatus 3000 which is connected to the tank venting system 1000. The control apparatus is designed to detect, to store, to evaluate, to interpret, to quantify, to qualitatively and quantitatively assess and to compare output signals from the storage pressure sensor 1510 and output signals from the tank pressure sensor 1520.

The fuel contained in the fuel tank 1210 tends to emit hydrocarbons. In the closed state, the shut-off valve 1400 prevents the gaseous hydrocarbons from escaping from the tank region 1200, as a result of which the pressure therein increases continuously. From time to time it is necessary to relieve the pressure in the tank region 1200. Placing the shut-off valve 1400 in the open state means that the gaseous hydrocarbons flow off into the fuel vapor store 1110 in a controlled manner due to the pressure drop and are temporarily stored therein. However, the fuel vapor store 1110 has a limited capacity and needs to be regenerated from time to time. To do this, the shut-off valve 1400 is closed and the ventilation valve 1610 is opened. Controlling the venting valve 1710 connects the fuel vapor store 1110 to the air intake pipe 1700, as a result of which, owing to the prevailing pressure drop, a flushing effect occurs, wherein the stored hydrocarbons are sucked into the air intake pipe 1700 and are then supplied to the internal combustion engine 2000, where they participate in the combustion. The flushing operation can be supported by operation of the pump 1620, this allowing the fuel vapor store 1110 to be flushed even in the case of a very low negative pressure around the air intake pipe.

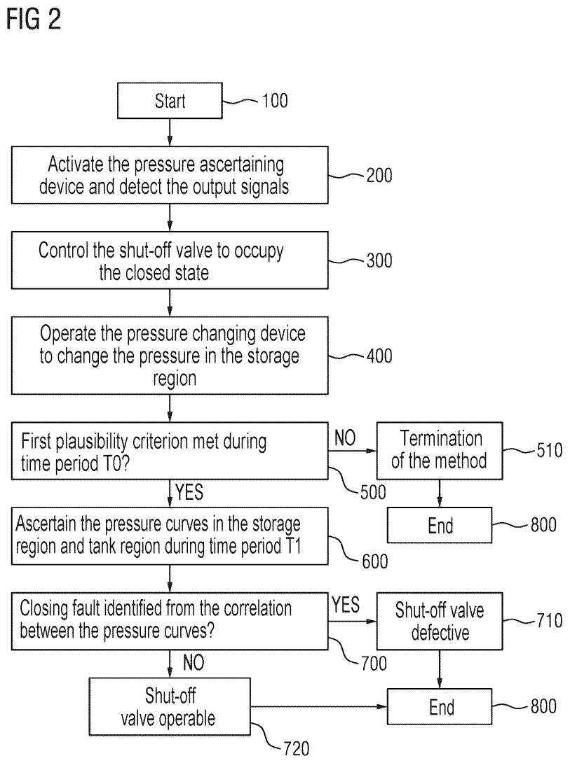

It is a legal requirement to check the functioning of the shut-off valve 1400. One exemplary embodiment of a method for checking the shut-off valve 1400 is explained in more detail with reference to the flowchart of FIG. 2. The method starts with step 100, for example when a vehicle driver starts the internal combustion engine.

In step 200, the pressure detecting device 1500 is activated or operated and its output signals are detected. This means that present output values from the storage pressure sensor 1510, which represent the pressure in the storage region, and present output values of the tank pressure sensor 1520, which represent the pressure in the fuel tank, are detected and stored at predetermined time intervals or continuously, e.g. by the control device 3000. The detecting and storing of these present output signals then takes place during all the following method steps.

In step 300, the shut-off valve 1400 is controlled to occupy the closed state. In the closed state, pressure equalization and gas flow between the storage region 1100 and the tank region 1200 are prevented. Controlling to occupy the closed state can be carried out, for example, by de-energizing the shut-off valve 1400 if it is a valve that is closed when de-energized.

In step 400, the pressure changing device 1800 is operated to change the pressure in the storage region 1100. In one configuration of the method, the pressure changing device 1800 remains activated over the course of the whole method. To produce a positive pressure, the venting valve 1710 is closed, the ventilation valve 1610 is opened and the pump 1620 is operated. To produce a negative pressure, the ventilation valve 1610 is closed or opened and the venting valve 1710 is opened, as a result of which the storage region 1100 is connected to the air intake pipe 2000 as a negative-pressure source.

In step 500, from the detected output signals from the pressure detecting device 1500, in particular from the output values from the storage pressure sensor 1510, a pressure curve in the storage region 1100 over a first time period TO is ascertained and evaluated to determine whether a first pressure change in the storage space 1100 caused by the operation of the pressure changing device 1800 meets a first plausibility criterion. In this case, the term “first pressure change” not only stands for the change in the pressure in terms of value at a certain point in time but is representative of all the quantitative and qualitative criteria, values, value sets, numbers, number sets, characteristic numbers and characteristic values with which a change in the pressure in the storage region 1100 can be characterized or quantified or assessed, e.g. the pressure gradient, the pressure curve (sequence of a plurality of pressure values at different points in time), the pressure change in terms of value at a certain point in time, the actual pressure value at a certain point in time relative to a predefined fixed comparison value, etc.

Thus, the first plausibility criterion is considered to be met, e.g., when, during the operation of the pressure changing device 1800, a first pressure gradient in the storage region 1100 ascertained on the basis of the output values from the storage pressure sensor 1510 at least reaches a predefined first gradient limit value or the first pressure gradient in the storage region (1100) remains within a predefined first pressure gradient value range or when a first pressure curve in the storage region 1100 follows a predefined first reference curve or the first pressure curve remains within a predefined first tolerance range around the first reference curve. In this case, the gradient limit value or the pressure gradient value range or the reference curve are expediently predefined so that the first plausibility criterion is only met when the amount of the pressure gradient in the storage region 1100 during the first time period TO does not fall below a predefined threshold value, which expediently is different from zero.

In some embodiments, during the first time period T0 a fluid mass flow through the storage region caused by the operation of the pressure changing device 1800, which can also be referred to as flushing mass flow, is ascertained. The ascertaining is carried out, for example, by modeling from measured values, e.g. measured values from the pressure detecting device 1500. In order to meet the first plausibility criterion, it is additionally required that the time integral of the fluid mass flow over the first time period T0 reaches or exceeds a predefined minimum value.

If it is determined in step 500 that the first plausibility criterion is not met, the method is thus terminated in step 510, in particular since the present pressure change then does not allow the pressure curves to be reliably evaluated, and the method ends in step 800.

If it is determined in step 500 that the first plausibility criterion is met, the method thus continues with step 600, wherein a time counter is started and the pressure curves in the storage region 1100 and in the tank region 1200 are ascertained by detecting output signals from the storage pressure detecting device 1510 and the tank pressure detecting device 1520 over a second time period T1. In the present case, the duration of the second time period is selected based on predefined time periods on the basis of output signals from the filling level sensor 1213.

In step 700, a correlation between the pressure curves ascertained over the second time period T1 in the storage region 1100 and in the tank region 1200 is evaluated. Furthermore, a closing fault of the shut-off valve 1400 is identified on the basis of the correlation between the pressure curves ascertained over the second time period T1 in the storage region 1100 and in the tank region 1200. In this case, in the present case, a closing fault of the shut-off valve 1400 is identified if during the second time period T1 the gradients of the pressure curves of the pressure in the tank region 1200 and of the pressure in the storage region 1100 have the same mathematical sign and the maximum pressure gradient of the pressure in the tank region 1200 in relation to the maximum pressure gradient of the pressure in the storage region 1100 within the second time period T1 exceeds a predefined limit value.

In some embodiments, the shut-off valve 1400 is subsequently controlled to occupy the open state, provided that no closing fault is detected. This configuration is not shown in FIG. 2. With regard to the additional features of this configuration, reference is made, in addition to the description below, to the description, claims and figures of the earlier International Application with the file number PCT/EP2022/057022, the disclosed contents of which are hereby incorporated into the present disclosure by reference.

This step (i.e. controlling the shut-off valve to occupy the open state) can be made dependent on whether the pressure in the tank region 1200 differs from the pressure in the storage region 1100 by a predefined minimum amount, wherein the shut-off valve 1400 is controlled to occupy the open state only if there is a positive test result. In the open state, pressure equalization and gas flow between the storage region 1100 and the tank region 1200 is now possible. As mentioned in step 400, the pressure changing device 1800 is still operated to change the pressure in the storage region.

In a subsequent step, in this configuration, the detected output signals from the pressure detecting device 1500 are evaluated to determine whether the second pressure change in the storage region 1100 caused by controlling the shut-off valve 1400 to occupy the open state meets a second plausibility criterion. In this step, it is checked whether the second pressure change in the storage region 1100 is plausible under the assumption of an actually open shut-off valve 1400. This is because, in the case where the shut-off valve 1400 is now actually in the open state, it is possible to identify a significant second pressure change compared to the case where the shut-off valve remains (is stuck) in the closed state. In this case, the term “second pressure change” also not only stands for the change in the pressure in terms of value at a certain point in time but is representative of all the quantitative and qualitative criteria, values, value sets, numbers, number sets, characteristic numbers and characteristic values with which a change in the pressure in the storage region can be characterized or quantified or assessed, e.g. the pressure gradient, the pressure curve (sequence of a plurality of pressure values at different points in time), the pressure change in terms of value at a certain point in time, the actual pressure value at a certain point in time relative to a predefined fixed comparison value, etc. The output values from the storage pressure sensor are used as a basis for ascertaining the “second pressure change”.

Thus, the second plausibility criterion is considered to be met, e.g., if, after the shut-off valve 1400 has been controlled to occupy the open state, a pressure gradient change in the storage region (1100) at least reaches a predefined minimum value or a second pressure gradient in the storage region (1100) is within a predefined second pressure gradient value range. In this case, the predefined minimum value is parameterized in such a way that in the case where the second pressure gradient change at least reaches said predefined minimum value, an actually open shut-off valve 1400 can be assumed. Accordingly, the predefined second pressure gradient value range is parameterized in such a way that in the case where the second pressure gradient is in this second pressure gradient value range, a properly opened shut-off valve 1400 can be assumed.

The second plausibility criterion is also considered to be met, e.g., if, after the shut-off valve has been controlled to occupy the open state, the pressure in the storage region (1100) changes by at least a predefined second pressure amount or the pressure in the storage region (1100) is within a predefined second pressure value range. In this case, the predefined second pressure amount is parameterized in such a way that in the case where the second pressure changes at least by this second pressure amount, a properly opened shut-off valve 1400 can be assumed. Accordingly, the predefined second pressure value range is parameterized in such a way that in the case where the pressure in the storage region 1100 is in this second pressure value range, a properly opened shut-off valve 1400 can be assumed.

The second plausibility criterion is also considered to be met, e.g., if, after the shut-off valve has been controlled to occupy the open state, a second pressure curve in the storage region 1100 follows a predefined second reference curve or the second pressure curve remains within a predefined second tolerance range around the second reference curve. In this case, the predefined second reference curve is parameterized in such a way that in the case where the second pressure curve follows the second reference curve, a properly opened shut-off valve 1400 can be assumed. Accordingly, the predefined second tolerance range is parameterized in such a way that in the case where the second pressure curve is within this second tolerance range, a properly opened shut-off valve 1400 can be assumed.

The parameters can be obtained, for example, through laboratory tests or through online tests in the vehicle.

If it is determined that the second plausibility criterion is not met, a fault of the shut-off valve 1400 is thus identified in a further step and the method ends in a subsequent step. This is because, if the shut-off valve 1400 were operable, it would thus have to have adopted its open state by being controlled to occupy the open state, as a result of which the pressure in the storage region 1100 would have to have changed to such an extent that the second pressure change criterion would have been met. If the second pressure change criterion is not met, however, it can thus be assumed that the pressure in the storage space 1100 has changed to an insufficient extent, this thus meaning that the shut-off valve 1400 is stuck in the closed state, that is to say it can no longer be opened.

If it is determined that the second plausibility criterion is met, the method continues with a step in which the shut-off valve 1400 is judged to be operable, and is then ended in a further step.

The method can be repeated regularly and/or in certain operating states of the internal combustion engine.

The method can be realized as a computer program product which can be loaded on a computer (microcomputer). The computer program product has software code sections which, when executed on the computer, execute corresponding arithmetic operations, output control commands and read in and process data. The computer program product can be loaded in the storage medium of a control apparatus 3000 (control unit), as schematically illustrated in FIG. 1. The control apparatus 3000 has all the required equipment features required for storing and executing the computer program product, for transmitting and for receiving data, and for controlling the tank venting system. In particular, the control apparatus 3000 has a digital storage medium, a processor, and interfaces for coupling to components of the tank venting system 1000 and to the internal combustion engine 2000.

What is claimed is:

1. A method for checking the operability of a controllable shut-off valve in a tank venting system,
the method comprising:
detecting a closed setpoint state of a shut-off valve or controlling the shut-off valve to occupy the closed setpoint state;
activating a pressure meter to measure a pressure in a storage region of the tank and a tank pressure;
operating a pressure changing device to change the pressure in the storage region;
ascertaining a pressure curve in the storage region using output signals from the pressure meter over a first time period and evaluating the ascertained pressure curve to determine whether a first pressure change in the storage space meets a first plausibility criterion;
ascertaining pressure curves in the storage region and in the tank using output signals from the storage pressure meter and the tank pressure meter over a second time period if the first plausibility criterion is met;
evaluating a correlation between the pressure curves ascertained over the second time period;
identifying a closing fault of the shut-off valve based on the correlation.

2. The method as claimed in claim 1, further comprising identifying a closing fault of the shut-off valve if, during the second time period, gradients of the pressure curves of the pressure in the tank region and of the pressure in the storage region have the same mathematical sign; and
A maximum pressure gradient of the pressure in the tank region in relation to the maximum pressure gradient of the pressure in the storage region within the second time period exceeds a predefined limit value, or a
difference between the pressure gradients of the pressure in the tank region and of the pressure in the storage region within the second time period remains within a predefined tolerance range.

3. The method as claimed in claim 1, wherein the tank region has a filling level sensor; and
a duration of the second time period is predefined based on detected signal from the filling level sensor.

4. The method as claimed in claim 1, further comprising ascertaining the pressure curve in the storage region using output signals from the storage pressure detecting device over a third time period and evaluating the ascertained pressure curve to determine whether a third plausibility criterion is met;
wherein the third plausibility criterion is met when the pressure curve ascertained over the third time period (T2) in the storage region is either monotonically increasing or monotonically decreasing, and
the relationship between the pressure curves ascertained over the second time period in the storage region and in the tank region is only evaluated if the third plausibility criterion is met.

5. The method as claimed in claim 1, wherein the beginning of the second time period is defined by a time counter or the beginning of the second time period and of the third time period is defined by the time counter.

6. The method as claimed in claim 1, further comprising, during the first time period, ascertaining a fluid mass flow through the storage region caused in particular by the operation of the pressure changing device and in order to meet the first plausibility criterion it is additionally required that a time integral of the fluid mass flow over the first time period reaches or exceeds a predefined minimum value.

7. The method as claimed in claim 1, wherein the elements are carried out repeatedly several times.

8. The method as claimed in claim 1, wherein in the event that no closing fault of the shut-off valve is identified, the method further comprises:
controlling the shut-off valve to occupy an open state;
evaluating the detected output signals from the pressure detecting device to determine whether a second pressure change in the storage space caused by controlling the shut-off valve to occupy the open state meets a second plausibility criterion; and
identifying an opening fault of the shut-off valve if the evaluation reveals that the second plausibility criterion is not met.

9. The method as claimed in claim 2, wherein the evaluation reveals that the second plausibility criterion is met if:
after the shut-off valve has been controlled to occupy the open state, a pressure gradient change in the storage region and/or in the tank region at least reaches a predefined minimum value or a second pressure gradient in the storage region and/or in the tank region is within a predefined second pressure gradient value range,
after the shut-off valve has been controlled to occupy the open state, the pressure in the storage region and/or in the tank region changes at least by a predefined second pressure amount of the pressure in the storage region and/or in the tank region is within a predefined second pressure value range, or
after the shut-off valve has been controlled to occupy the open state, a second pressure curve in the storage region and/or in the tank region follows a predefined second reference curve or the second pressure curve remains within a predefined second tolerance range around the second reference curve.

10. The method as claimed in claim 1, wherein the pressure changing device includes:
a ventilation line via which a fuel vapor store is connected to the atmosphere; y
a controllable ventilation valve arranged in the ventilation line to control gas flow through the ventilation line;
a venting line via which the fuel vapor store is connected to a negative-pressure source; and
a controllable venting valve arranged in the venting line to control the gas flow through the venting line;
wherein in order to change the pressure in the storage region the ventilation valve is closed and the venting valve is opened in order to produce a negative pressure in the storage region.

11. The method as claimed in claim 1, wherein the pressure changing device includes:
a ventilation line via which the fuel vapor store is connected to the atmosphere;
a controllable ventilation valve arranged in the ventilation line to control the gas flow through the ventilation line;
venting line via which the fuel vapor store is connected to a negative-pressure source; and
a controllable venting valve arranged in the venting line to control the gas flow through the venting line;
wherein in order to change the pressure in the storage region the ventilation valve and the venting valve are opened in order to produce a negative pressure in the storage region.

12. The method as claimed in claim 1, wherein the pressure changing device includes:
a ventilation line via which the fuel vapor store is connected to the atmosphere;
a controllable ventilation valve arranged to control the gas flow through the ventilation line;
a controllable pump downstream of the ventilation valve in the ventilation line to pump ambient air from the atmosphere into the fuel vapor store to produce a positive pressure in the storage region;
a venting line via which the fuel vapor store is connected to a negative-pressure source; and
a controllable venting valve arranged to control the gas flow through the venting line;
wherein in order to change the pressure in the storage region the ventilation valve is opened, the venting valve is closed, and the pump is operated to produce a positive pressure in the storage region.

13. The method as claimed in claim 1, wherein the storage pressure detecting device comprises a virtual sensor and the output signals from the storage pressure detecting device are based on a pressure calculated or measured downstream of the venting valve.

14-15. (canceled)

16. A tank venting system comprising:
a tank region including a fuel tank;
a storage region with a fuel vapor store
an exhaust line connecting the fuel vapor store to the fuel tank;
a controllable shut-off valve arranged in the exhaust line and which in a closed state prevents pressure equalization between the tank region and the storage region and which in an open state allows pressure equalization between the tank region and the storage region;
a pressure changing device connected to the storage region to change a pressure in the storage region;
a pressure meter with a storage pressure detecting device for detecting the pressure in the storage region and a tank pressure detecting device for detecting the pressure in the tank region; and
a control device programmed to:
detect a closed setpoint state of the shut-off valve or control the shut-off valve to occupy the closed setpoint state;
activate the pressure detecting device;
operate the pressure changing device to change the pressure in the storage region;
ascertain a pressure curve in the storage region using output signals from the storage pressure detecting device over a first time period;
evaluate the ascertained pressure curve to determine whether a first pressure change in the storage space caused by the operation of the pressure changing device meets a first plausibility criterion,
ascertain the pressure curves in the storage region and in the tank region using output signals from the storage pressure detecting device and the tank pressure detecting device over a second time period if the first plausibility criterion is met;
evaluate a correlation between the pressure curves ascertained over the second time period in the storage region and in the tank region; and
identify a closing fault of the shut-off valve on the basis of the correlation between the pressure curves ascertained over the second time period in the storage region and in the tank region.
